(19) United States
(12) Patent Application Publication
(10) Pub. No.: US 2004/0089251 A1
(43) Pub. Date: May 13, 2004

(54) Water cooled rotary internal combustion machine

(76) Inventor: John Alejandro Sanchez Talero, Santa Fe de Bogota (CO)

Correspondence Address: KRAMER & AMADO, P.C., 2001 JEFFERSON DAVIS HWY, SUITE 1101, ARLINGTON, VA, 22202, US

(21) Appl. No.: 10/473,750

(22) PCT Filed: Apr. 2, 2001
(86) PCT No.: PCT/IB01/00539

(51) Int. Cl. F02B 53/00

(52) U.S. Cl. 123/45 R

(57) ABSTRACT

The invention is related to the Revolvable Motor of Internal Combustion “TURBOVOLANTE” (turbine-steering wheel). This Cinematic System is good to rotate through fuels or magnetic fields, it works as a vacuum Pump or Compressor of gases like propane, oxygen, etc. and this work is carried out it by means of rectangular Fins that expand and contract moving a Crankshaft and it Pinion that leans on a Toothed Ring inside, moving or fixed pinion of the Stator. With ratios 2:1 in that of 4 Fins, 4:1 in that of 8 Fins, and 6:1 in that of 12 Fins. The invention gives a fixed cylinder to rotors some with grooves for the entrance and evacuation of gases and explosions, which are carried out inside the rotor in 90%.

Its refrigeration is through Water that passes from one place to another of the Stator.

Nowadays there exist several motor of internal combustion that carry out the 4 strokes in a single revolution, carrying out their admission and escape through nozzles economizing, the power used for the movement of valves since they are revolvable they do not need steering while for their normal operation, there are some pistons, with triangular Rotor (Wankel) or fins. One of the problems that present is the remaining and the force (brake rotor) that generates the pressure of the gas expanded among the piston, triangular rotor (Wankel) or fins when leaning on in the stator, in the moment of its displacement.

The present invention refers to the denominated Revolvable Motor of internal combustion “TURBOVOLANTE” where is energy is produced in rectangular chambers through rectangular fins that pivot in one of its ends pushing the connecting rods that move some crankshafts, with pinions that lean on inwardly in a teethed ring or pinion (crowns) fixed to stator, with relationships two to one (2:1), for the motor of four fins, and makes a cycle (four strokes) in a turn, relationship four to one, for that of eight fins and make two cycles for turn and relationship six to one and makes three cycles for turn, the rotor rotates pushing through the being of the crankshafts support one the lateral disks of the rotor, when its pinions advance, the magnetic motor works with the same cinematic principle than the previous one contrary to that doesn't have admission nozzles and escape, and they don't have seals for the remaining, and that their fins are magnets with the same magnetic load, toward the stator and they are repelled or attracted by means of electromagnets located in the whole periphery of stator, and they are controlled by a conventional electronic panel, changing their polarity depending on the position of fins, placing the same magnetic load that repels (pushes) the fins when they are in the nearest point to the stator and when fins are in maximum point of distance of the stator, it changes the magnetic load of the electromagnet, to the one opposed to the fin attracting it toward the stator, at the same time the same thing happens in all fins magnetic motor of four fins, eight fins and twelve fins. With this cinematic principle it is also claimed the production of compressors and vacuum pumps. A motor like this is described in the document deposited in Washington (USA) August 2000 No. 09/633,623, I Document in the European Patent Office with number 00500195.3 deposited September 05 200 in Madrid (Spain). These documents with priority in Colombia, deposited in Bogota September 8 of 1999 number 99056673.

The present invention provides to the motor previously mentioned, reduction of the pressure between the rotor and the stator generated by the expansion of gases that brakes the push to the rotor, smaller friction on the part of the vertical seals between the rotor and the stator, being its refrigeration more efficient as it is through the water. The reduction of the pressure is achieved, anchoring in the periphery of the rotor, a cylinder to the lateral plates of rotor by means of screws that has a strip of holes in cavities, allowing the entrance and evacuation of gases, leaning on the pressure, of the expansion of the explosion, inside the same rotor, only leaning on the stator the surface corresponding to holes or grooves. The friction of seals diminishes, since they are not mounted on the periphery of the plates of rotor, but, in the cylinder in the edges of the strip of holes or grooves, making shorter the vertical seals, leaving this way less surface to seal, providing a bigger remaining, this is valid for compressors and vacuum pumps with this cinematic form, enabling them for suction and pumping of inflammable gases as propane.

In the case of magnetic motor, this cylinder (careening) it is used without holes or grooves, in on magnetic materials for the placement of sensors helping to control the changes of the magnetism of electromagnets. This cylinder in the rotor also contributes to the protection of entrance of foreign matters into the chambers where the fin-magnet pivot.

The invention is described now by references to the enclosed drawings in which:

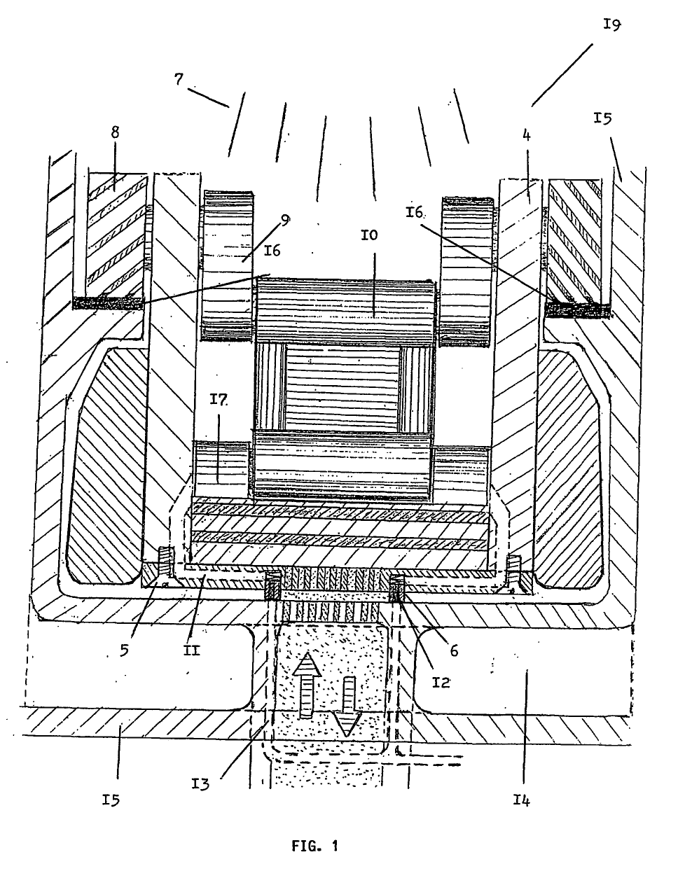

FIG. 1 shows a view of a longitudinal cut of the motor showing the stator and the rotor with the cylinder and its strip with holes and/or cavities according to the invention.

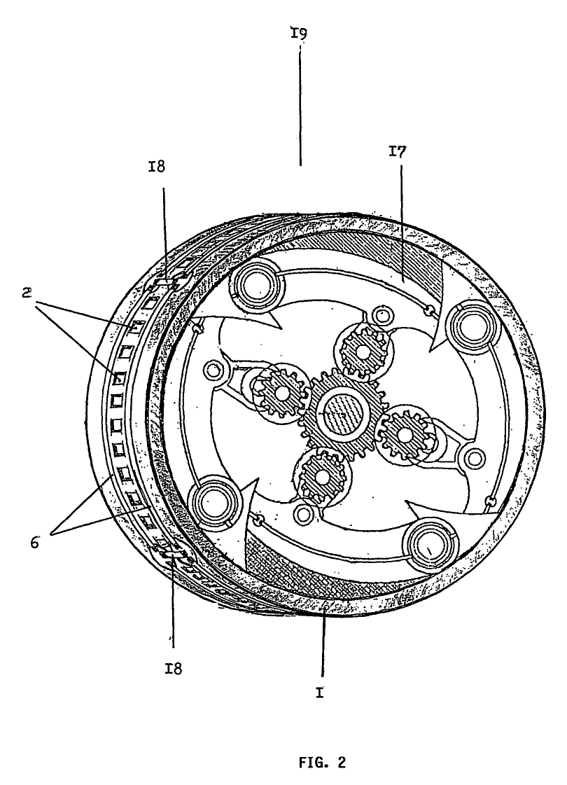

FIG. 2 shows a rotor in perspective of 4 fins and the cylinder with hole or grooves according to the invention.

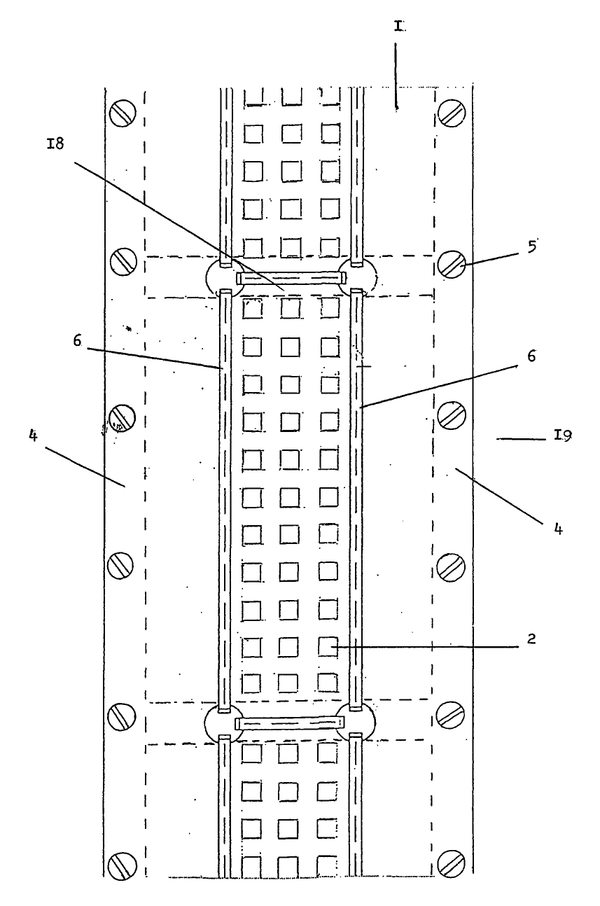

FIG. 3 shows the periphery of the rotor, corresponding to the cylinder with strip holes or grooves in square form.

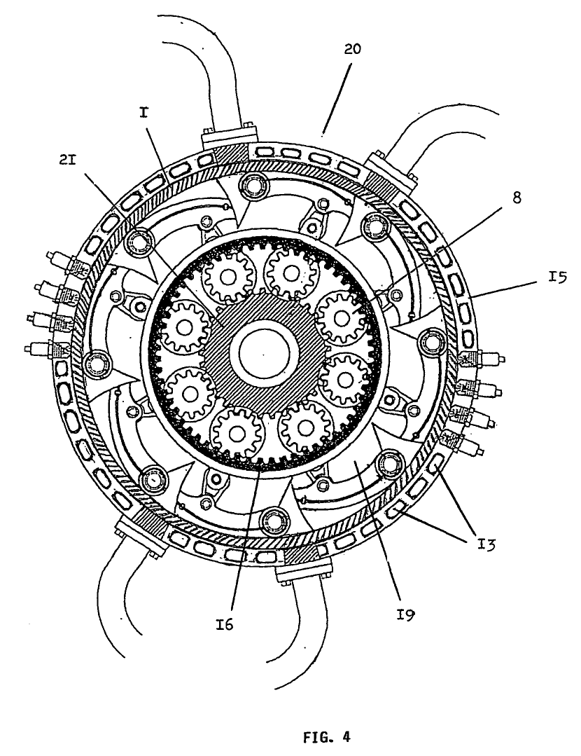

FIG. 4 is a lateral view of a motor with 8 fins support in a toothed ring or a pinion fixed to the stator, it has the cylinder to careen the rotor. It shows the water conduits, according to the invention.

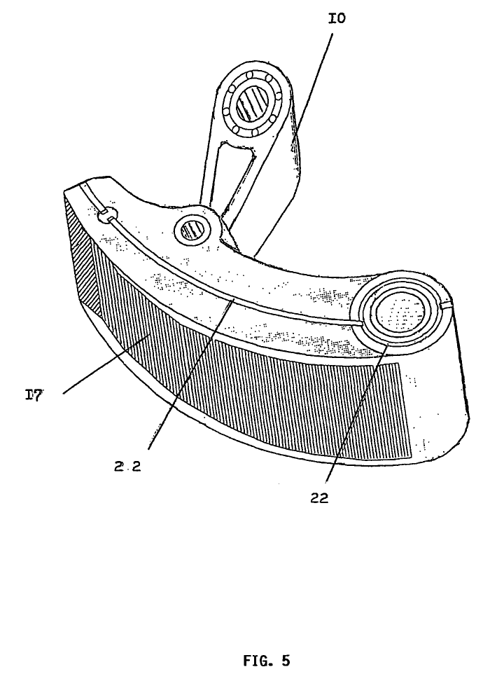

FIG. 5 is a view in perspective of a fin of the combustion motor, magnetic, compressor or vacuum pump with their seals apex.

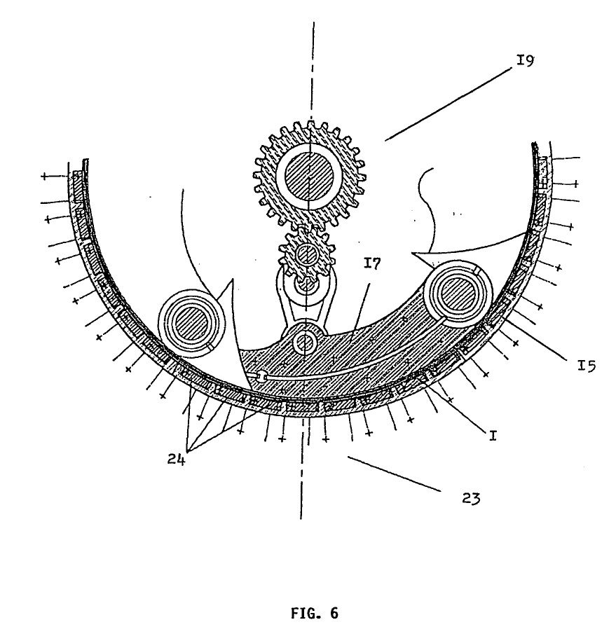

FIG. 6 is a lateral view of one of the fin-magnet of the magnetic motor where their rotor has it cylinder—careening reason of the invention.

FIG. 1 allows to observes a front cut of a part of the revolvable motor in internal combustion “TURBOVOLANTE” where it has in its rotor 19 a cylinder 1 with holes or grooves 2 that meet with the holes of stator 3 anchored to lateral disks of rotor 4 through screws 5. This cylinder supports the peripheral seals 6 that make the remaining and they are good to evacuate the oil 7 that enters through the center of motor 20 and it is spread to mobile pieces; pinions 8 that lean on in an inwardly toothed ring fixed 16 to the stator 15, crankshafts 9, connecting rods 10, fins 17 and it is extracted through conduits of disks 4 of rotor 19 passing by conduits 12 of the peripheral seals 6 to conduits 13 of stator 15 by the action of centrifugal force and the pump of oil. It has stator 15 with cavities 14 in its periphery that allow the passing of ware from one side to the other of motor 20 for refrigeration.

FIG. 2 shows a rotor 19 of 4 fins 17 either of; internal, magnetic combustion, vacuum pump or compressor, where in its cylinder 1 it has a strip of holes or grooves 2 beside the seals apex 6 through its seals vertical apex 18.

FIG. 3 shows the periphery of cylinder 1 anchored to lateral walls 4 of rotor 19 through screws 5 in whose cylinder 1 the peripheral seals 6 are and vertical seals 18, the holes or grooves 2 of cylinder 1 in this example are square.

FIG. 4 shows a removable motor “TURBOVOLANTE” 20 where in its pinions 8 lean on an internally ring 16 or on a pinion 21 fixed to the stator 15 in its rotor 19 it has the cylinder 1 that careens and it is part of rotor 19, it also has conduits 13 in stator 15 that allow the passing of water from one end to another for its refrigeration.

FIG. 5 shows a view in perspective of fins 17 with its connecting rod 10 which generates the movement of the rotor of the motor of internal combustion “TURBOVOLANTE,” magnetic motor, compressor and revolvable vacuum pump and its remaining is done through seals fins, apex 22 of Wankel motor.

FIG. 6 shows a fin-magnet 17 of 4 magnetic fins 23 where the rotor 19 has the cylinder 1 anchored in the rotor without grooves and permits the passing, of the magnetism generated by the electromagnets 24 located in stator 15.

1. Cylinder-careening of the Rotor, and Refrigeration by means of Water, of the Revolvable System “TURBOVOLANTE”: for: the Motors of Internal Combustion, Magnetic Motors, Compressors and vacuum pumps.

2. Cylinder-careening of Rotor, or the “TURBOVOLANTE” System for the Internal Combustion Motors; Magnetic motors, Compressors, vacuum Pumps, according to claim 1 and Characterized for having in Rotors a Cylinder anchored in its periphery through screws that thread around the Lateral Disks.

3. Cylinder-careening of the Rotor, of the “TURBOVOLANTE” Revolvable System for the Motors of Internal Combustion, Compressors and vacuum Pumps, according to claim 2 Characterized to have a strip of Holes or Grooves, with different forms: Square, Triangular and/or Rectangular, located in lines from one to twenty in the periphery of the cylinder of the Rotor placing the peripheral seals Apex beside the strip.

4. Refrigeration by means of Water of the “TURBOVOLANTE” Revolvable System for magnetic Motors of Internal Combustion, Compressors and vacuum Pumps according to claim 1, providing its stators with peripheral Conduits that allow the passing of Water from one side to the other.

5. Cylinder-careening of Rotor of the “TURBOVOLANTE” System for the Magnetic Motors according to claim 1 and characterized because the Rotors of Four, Eight and Twelve Fin-magnet have cylinders anchored in their Rotor in the Peripheral part in non Magnetic Materials.
